(19) United States
(12) Patent Application Publication
(10) Pub. No.: US 2021/0255791 A1
(43) Pub. Date: Aug. 19, 2021

(54) DISTRIBUTED STORAGE SYSTEM AND DATA MANAGEMENT METHOD FOR DISTRIBUTED STORAGE SYSTEM

(71) Applicant: Hitachi, Ltd., Tokyo (JP)

(72) Inventors: Akio SHIMADA, Tokyo (JP); Mitsuo HAYASAKA, Tokyo (JP)

(73) Assignee: Hitachi, Ltd.

(21) Appl. No.: 17/018,765

(22) Filed: Sep. 11, 2020

(30) Foreign Application Priority Data
Feb. 17, 2020 (JP) 2020-024516

(51) Int. Cl. G06F 3/06

(52) U.S. Cl. CPC G06F 3/0641; G06F 3/0659; G06F 3/067; G06F 3/0604; G06F 3/0652

(57) ABSTRACT

Provided is a distributed storage device that reduces the number of inter-node communication in inter-node deduplication. The storage node determines whether data that is a processing target duplicates with data stored in the shared block storage. When it is determined that the data is duplicated, deduplication of the data that is the processing target is performed by storing information on a storage destination of the data related to the duplication with a storage node that processes the data that is the processing target. When a read request of the data is received, the storage node that processes the data that is the processing target reads the data in the shared block storage using the information on the storage destination.

### BACKGROUND OF THE INVENTION

### 1. Field of the Invention

The present invention relates to a distributed storage system and a data management method for a distributed storage system.

### 2. Description of the Related Art

In order to store a large amount of data used in data analysis such as artificial intelligence (AI), a scale-out type distributed storage has been widely used. In order to efficiently store the large amount of data, the scale-out type distributed storage requires capacity reduction techniques such as deduplication and compression.

An example of the capacity reduction techniques for the distributed storage includes inter-node deduplication. This is a technique for extending a deduplication technique of eliminating duplicated data in a storage to the distributed storage. In the inter-node deduplication, not only data that is duplicated within one storage node that constitutes the distributed storage but also data that is duplicated among a plurality of storage nodes can be reduced, and the data can be stored more efficiently. The inter-node deduplication technique is disclosed in, for example, U.S. Pat. Nos. 8,930,648 and 9,898,478 (Patent Literatures 1 and 2).

In the distributed storage, data is divided and distributed to the plurality of nodes that constitute the distributed storage. A node that receives an IO request from a client transfers the request to a node having IO target data. The node that receives the transferred request performs reading and writing on the IO target data stored in a disk device, and transmits a processing result to the node that receives the IO request from the client. The node that receives the process result transmits the processing result to the client.

At this time, when the IO target data is duplicated data that has been deduplicated, there is a possibility that the IO target data does not exist in the node to which the IO request is transferred. In this case, it is necessary to further transfer the IO request from the node to which the IO request is transferred to a node that stores the duplicated data. As a result, in the inter-node deduplication technique in the related art, the number of inter-node communication that occurs to process the IO request from the client increases, and IO performance of the distributed storage lowers.

### SUMMARY OF THE INVENTION

The invention has been made in view of the above-mentioned circumstances, and an object thereof is to provide a distributed storage system and a data management method for a distributed storage system that can reduce the number of inter-node communication in inter-node deduplication.

In order to achieve the above-mentioned object, there is provided a distributed storage device including a plurality of storage nodes and a storage device configured to physically store data. Each of the storage nodes has information on a storage destination of the data stored in the storage device and a deduplication function. In the deduplication function, any one of the plurality of storage nodes determines whether data that is a processing target duplicates with the data stored in the storage device. When it is determined that the data is duplicated, deduplication of the data that is the processing target is performed by storing the information on the storage destination of the data in the storage device that is related to the duplication with a storage node that processes the data that is the processing target. When a read request of the data is received, the storage node that processes the data that is the processing target reads the data in the storage device using the stored information on the storage destination.

According to the invention, the number of inter-node communication in inter-node deduplication can be reduced.

### BRIEF DESCRIPTION OF THE DRAWINGS

FIG. 1 is a block diagram showing a schematic configuration of a distributed storage system according to a first embodiment.

FIG. 2 is a block diagram showing an example of a hardware configuration of the distributed storage system according to the first embodiment.

FIG. 3 is a block diagram showing an example of a theoretical configuration of the distributed storage system according to the first embodiment.

FIG. 4 is a diagram showing a configuration of an update management table of FIG. 3.

FIG. 5 is a diagram showing a configuration of a pointer management table of FIG. 3.

FIG. 6 is a diagram showing a configuration of a hash table of FIG. 3.

FIG. 7 is a flowchart showing a read processing of the distributed storage system according to the first embodiment.

FIG. 8 is a flowchart showing an inline deduplication write processing of the distributed storage system according to the first embodiment.

FIG. 9 is a flowchart showing a duplicated data update processing of FIG. 8.

FIG. 10 is a flowchart showing an inline deduplication processing of FIG. 8.

FIG. 11 is a flowchart showing a post-process deduplication write processing of the distributed storage system according to the first embodiment.

FIG. 12 is a flowchart showing a post-process deduplication processing of the distributed storage system according to the first embodiment.

FIG. 13 is a block diagram showing an example of a hardware configuration of a distributed storage system according to a second embodiment.

FIG. 14 is a block diagram showing an example of a theoretical configuration of the distributed storage system according to the second embodiment.

FIG. 15 is a flowchart showing a read processing of the distributed storage system according to the second embodiment.

FIG. 16 is a block diagram showing an example of a hardware configuration of a distributed storage system according to a third embodiment.

### DESCRIPTION OF THE PREFERRED EMBODIMENTS

Embodiments will be described with reference to the drawings. It should be noted that the embodiments described below do not limit the invention according to the claims, and all elements and combinations thereof described in the embodiments are not necessarily essential to the solution to the problem of the invention.

In the following description, there is a case where processing is described using a “program” as a subject. Since the program is executed by a processor (for example, a central processing unit (CPU)) to perform a determined processing appropriately using a memory resource (for example, a memory) and/or a communication interface device (for example, a port), the subject of the processing may be the processor. The processing described using the program as the subject may be the processing performed by the processor or a computer including the processor.

### First Embodiment

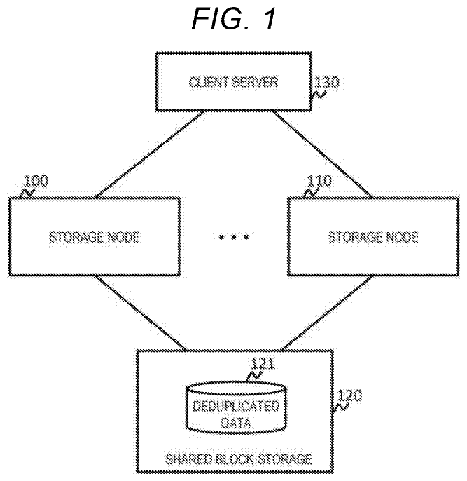

FIG. 1 is a block diagram showing a schematic configuration of a distributed storage system according to a first embodiment.

In FIG. 1, the distributed storage system includes a plurality of distributed storage nodes 100 to 110, a shared block storage 120, and a client server 130.

The shared block storage 120 is shared by the plurality of storage nodes 100 to 110. The shared block storage 120 includes a shared volume 121 that stores deduplicated data. Any one of the storage nodes 100 to 110 can access the shared volume 121. The deduplicated data is data that has been deduplicated from the storage nodes 100 to 110 with respect to duplicated data (deduplication target data) that is duplicated among the storage nodes 100 to 110. The deduplicated data may include data that has been deduplicated from one storage node that constitutes a distributed storage with respect to duplicated data that is duplicated in the storage node.

The storage nodes 100 to 110 operate in coordination to constitute the distributed storage. Although there are two storage nodes 100 to 110 shown in FIG. 1, the distributed storage may be configured with more than two storage nodes. The number of the storage nodes 100 to 110 that constitute the distributed storage may be any number.

In the distributed storage, any one of the storage nodes 100 to 110 receives an IO request (read request or write request of data) which is a data input and output request from the client server 130, communicates with each other via a network, and operates in coordination among the storage nodes 100 to 110 to perform an IO processing. The storage nodes 100 to 110 perform a deduplication processing on the duplicated data that is duplicated among the storage nodes 100 to 110, and store the deduplicated data in the shared volume 121 on the shared block storage 120.

Herein, the respective storage nodes 100 to 110 can read the duplicated data requested to be read by the client server 130 from the shared volume 121. Therefore, it is possible to reduce the number of inter-node communication for reading the duplicated data even when a host node of the respective storage nodes 100 to 110 does not store the duplicated data requested to be read by the client server 130.

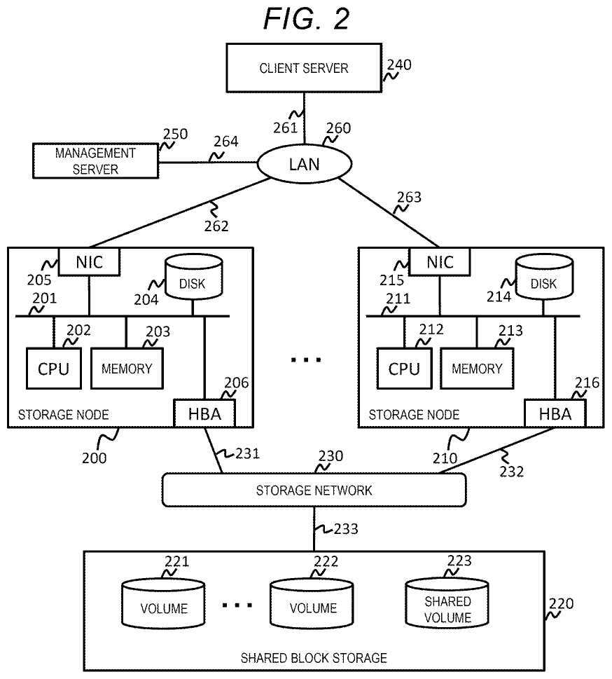

FIG. 2 is a block diagram showing an example of a hardware configuration of the distributed storage system according to the first embodiment.

In FIG. 2, the distributed storage system includes a plurality of distributed storage nodes 200 to 210, a shared block storage 220, and a client server 240. The storage nodes 200 to 210 execute a distributed storage program and operate integrally to constitute the distributed storage. Although there are two storage nodes 200 to 210 shown in FIG. 2, the distributed storage may be configured with more than two storage nodes 200 to 210. The number of the storage nodes 200 to 210 that constitute the distributed storage may be any number.

Each of the storage nodes 200 to 210 is connected to a storage network 230 via lines 231 to 232. The shared block storage 220 is connected to the storage network 230 via a line 233.

Further, each of the storage nodes 200 to 210 is connected to a local area network (LAN) 260 via lines 262 to 263. The client server 240 is connected to the LAN 260 via a line 261. A management server 250 is connected to the LAN 260 via a line 264.

The shared block storage 220 is a storage device that physically stores data of the storage nodes 200 to 210. In the shared block storage 220, volumes 221 to 222 are set as individual volumes that respectively store data of the storage nodes 200 to 210 that has not been deduplicated. Further, in the shared block storage 220, a shared volume 223 that stores deduplicated data and shares the data among the storage nodes 200 to 210 is allocated.

A volume is provided for each storage node. Specifically, the volume 221 is a volume for the storage node 200, and the other storage node 210 cannot read data from and write data to the volume 221. The volume 222 is a volume for the storage node 210, and the other storage node 200 cannot read data from and write data to the volume 222. Each of the storage nodes 200 and 210 can read data from and write data to the shared volume 223.

The storage node 200 includes a central processing unit (CPU) 202, a memory 203, a disk 204, a network interface card (NIC) 205, and a host bus adapter (HBA) 206. The CPU 202, the memory 203, the disk 204, the NIC 205, and the HBA 206 are connected to each other via a bus 201.

The memory 203 is a main storage device that can be read and written by the CPU 202. The memory 203 is, for example, a semiconductor memory such as an SRAM or a DRAM. The memory 203 can store a program being executed by the CPU 202, or can be provided with a work area for the CPU 202 to execute the program.

The disk 204 is a secondary storage device that can be read and written by the CPU 202. The disk 204 is, for example, a hard disk device or a solid state drive (SSD). The disk 204 can store execution files of various programs and data used for executing the programs.

The CPU 202 reads a distributed storage program stored in the disk 204 into the memory 203 and executes it. The CPU 202 is connected to the NIC 205 via the bus 201, and can transmit data to and receive data from other storage nodes and the client server 240 via the LAN 260 and the lines 261 to 263. The CPU 202 is connected to the HBA 206 via the bus 201, and can transmit data to and receive data from the shared block storage 220 via the storage network 230 and the lines 231 and 233. At this time, the CPU 202 can read data from and write data to the volume 221 and the shared volume 223 on the shared block storage 220.

The storage node 210 includes a CPU 212, a memory 213, a disk 214, an NIC 215, and an HBA 216. The CPU 212, the memory 213, the disk 214, the NIC 215, and the HBA 216 are connected to each other via a bus 211.

The memory 213 is a main storage device that can be read and written by the CPU 212. The memory 213 is, for example, a semiconductor memory such as an SRAM or a DRAM. The disk 214 is a secondary storage device that can be read and written by the CPU 212. The disk 214 is, for example, a hard disk device or an SSD.

The CPU 212 reads a distributed storage program stored in the disk 214 into the memory 213 and executes it. The CPU 212 is connected to the NIC 215 via the bus 211, and can transmit data to and receive data from other storage nodes and the client server 240 via the LAN 260 and the lines 261 to 263. The CPU 212 is connected to the HBA 216 via the bus 211, and can transmit data to and receive data from the shared block storage 220 via the storage network 230 and the lines 232 and 233. At this time, the CPU 212 can read data from and write data to the volume 222 and the shared volume 223 on the shared block storage 220.

The management server 250 is connected to the storage nodes 200 to 210 that constitute the distributed storage via the LAN 260 and the line 264, and manages the storage nodes 200 to 210.

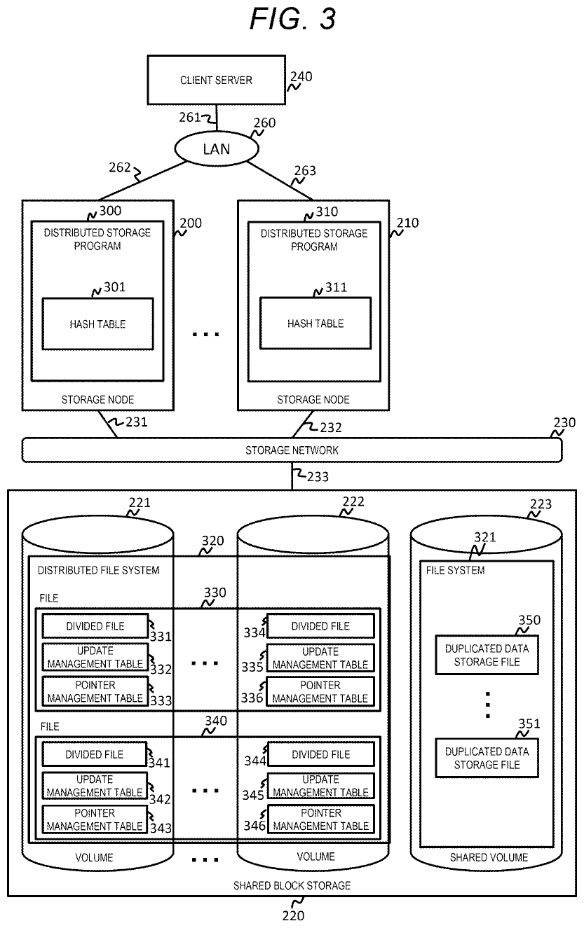

FIG. 3 is a block diagram showing an example of a theoretical configuration of the distributed storage system according to the first embodiment.

In FIG. 3, a distributed storage program 300 executed on the storage node 200, a distributed storage program 310 executed on the storage node 210, and distributed storage programs (not shown in the figure) operating on the other storage nodes operate in coordination to constitute the distributed storage.

The distributed storage constructs a distributed file system 320 across the plurality of volumes 221 to 222 on the shared block storage 220. The distributed storage manages data in units of files 330 and 340. The client server 240 can read data from and write data to each of the files 330 and 340 on the distributed file system 320 via the distributed storage.

Each of the files 330 and 340 on the distributed file system 320 is divided into a plurality of files (divided files) and the plurality of divided files are respectively distributed in the volumes 221 to 222 allocated to the storage nodes 200 to 210.

The file 330 is divided into divided files 331 and 334 respectively distributed in the volumes 221 to 222 allocated to each of the storage nodes 200 to 210. For example, the divided file 331 is disposed in the volume 221 allocated to the storage node 200, and the divided file 334 is disposed in the volume 222 allocated to the storage node 210. Although not shown in FIG. 3, the file 330 may be divided into more divided files.

Further, the file 340 is divided into divided files 341 and 344 respectively distributed in the volumes 221 to 222 allocated to each of the storage nodes 200 to 210. For example, the divided file 341 is disposed in the volume 221 allocated to the storage node 200, and the divided file 344 is disposed in the volume 222 allocated to the storage node 210. Although not shown in FIG. 3, the file 340 may be divided into more divided files.

Which storage node having an allocated volume a divided file is to be stored is determined by any algorithm. An example of the algorithm is controlled replication under scalable hashing (CRUSH). Either of the divided files 341 and 344 is managed by a corresponding one of the storage nodes 200 to 210 to which one of the volumes 221 to 222 that stores a corresponding one of the divided files 341 and 344 is allocated.

Either of the files 330 and 340 on the distributed file system 320 stores an update management table and a pointer management table in addition to a divided file. The update management table manages an update status of a divided file. The pointer management table manages pointer information to duplicated data. The update management table and the pointer management table are provided for each divided file.

In the example of FIG. 3, an update management table 332 and a pointer table 333 corresponding to the divided file 331 are stored in the volume 221, and an update management table 335 and a pointer table 336 corresponding to the divided file 334 are stored in the volume 222. Further, an update management table 342 and a pointer table 343 corresponding to the divided file 341 are stored in the volume 221, and an update management table 345 and a pointer table 346 corresponding to the divided file 344 are stored in the volume 222.

Further, the distributed storage constructs a file system 321 on the shared volume 223. The file system 321 stores duplicated data storage files 350 to 351.

Further, in the distributed storage, duplicated data that is duplicated in the distributed file system 320 is eliminated from the distributed file system 320, and the duplicated data eliminated from the distributed file system 320 is stored in the duplicated data storage files 350 to 351 on the file system 321 as the deduplicated data. A plurality of duplicated data storage files 350 to 351 are created and allocated to the respective distributed storage nodes 100 to 110. The duplicated data that is duplicated in the distributed file system 320 may be the duplicated data that is duplicated between the divided files 341 and 344, or may be the duplicated data that is duplicated in either of the divided files 341 and 344.

In the example of FIG. 3, the duplicated data storage file 350 is allocated to the storage node 200, and the duplicated data storage file 351 is allocated to the storage node 210. The distributed storage programs 300 to 310 on the respective storage nodes 200 to 210 can write data only in the duplicated data storage files 350 to 351 allocated to the respective storage nodes 200 to 210. The storage nodes 200 to 210 cannot write data in duplicated data storage files allocated to the other storage nodes. However, the respective storage nodes 200 to 210 can read data of duplicated data storage files allocated to other storage nodes.

The distributed storage programs 300 to 310 respectively store hash tables 301 to 311 as information of storage destinations of data stored in the shared block storage 220. In the example of FIG. 3, the distributed storage program. 300 stores the hash table 301, and the distributed storage program 310 stores the hash table 311. Hash values stored by the storage nodes 200 to 210 can be divided with a range of the hash values and distributed to the storage nodes 200 to 210.

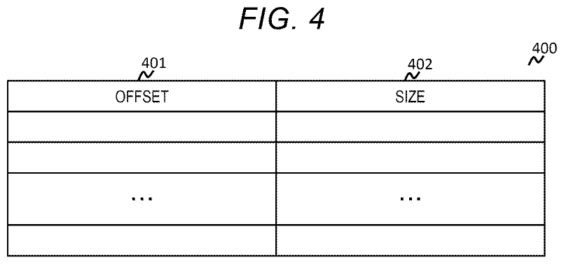

FIG. 4 is a diagram showing a configuration of an update management table of FIG. 3.

In FIG. 4, an update management table 400 is used to manage an update status of a divided file. The update management table 400 is provided for each divided file and is stored as a set with the divided file in a volume that stores the divided file. When the divided file is updated, an offset value at a beginning of an update part is recorded in a column 401, and an update size is recorded in a column 402.

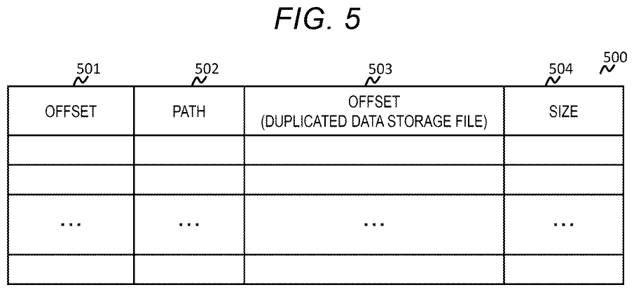

FIG. 5 is a diagram showing a configuration of a pointer management table of FIG. 3.

In FIG. 5, a pointer management table 500 is used to manage pointer information to the duplicated data. The pointer management table 500 (pointer information) can be used as deduplication information indicating that the deduplication is performed, and can also be used as access information for accessing the duplicated data.

The pointer management table 500 is provided for each divided file and is stored as a set with the divided file in a volume that stores the divided file. In a column 501, an offset value at a beginning of a portion that is the duplicated data in the divided file is recorded. In a column 502, a path on a file system of a duplicated data storage file that stores the duplicated data is recorded. In a column 503, an offset value at a beginning of a portion that stores the duplicated data in the duplicated data storage file is recorded. In a column 504, a size of the duplicated data is recorded.

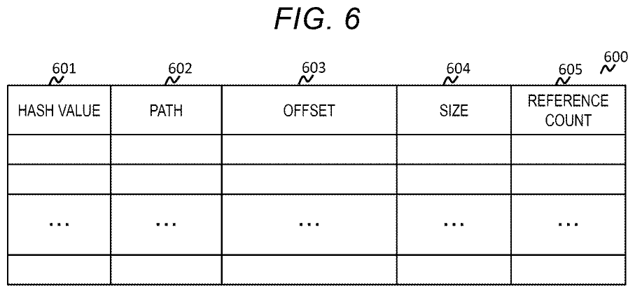

FIG. 6 is a diagram showing a configuration of a hash table of FIG. 3.

In FIG. 6, a hash table 600 is used to manage data written on the distributed storage. In a column 601, a hash value of data written in a file on the distributed storage is recorded. In a column 602, a path on a distributed file system of a divided file that stores the data or a path on a file system of a duplicated data storage file that stores the data is recorded. In a column 603, an offset value at a beginning of a portion that stores the data in a file that stores the data is recorded. In a column 604, a size of the data is recorded. Ina column 605, a reference count of the data is recorded. When the data is the duplicated data, the reference count is equal to or greater than 2.

The hash table 600 is stored in a memory on each storage node. A range of the hash value managed by each storage node is predetermined, and which hash table of a storage node information is to be recorded is determined according to a hash value of data managed by each storage node.

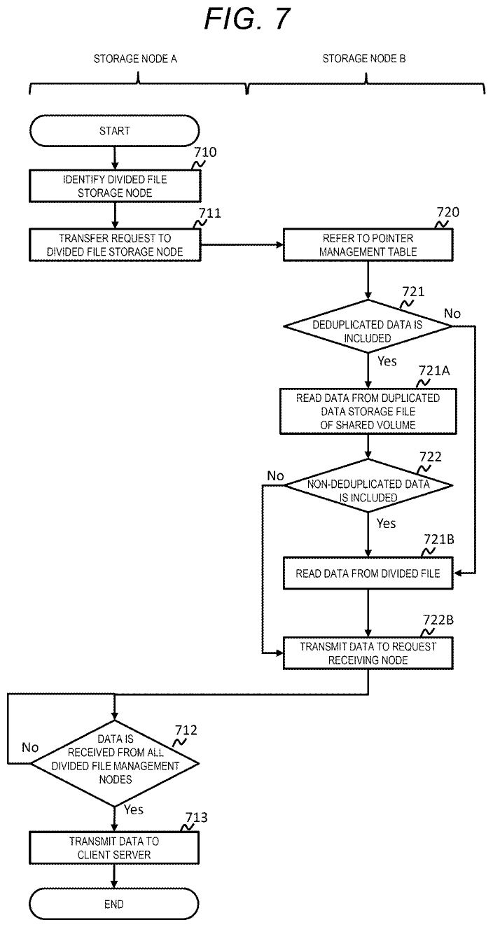

FIG. 7 is a flowchart showing a read processing of the distributed storage system according to the first embodiment. FIG. 7 shows the read processing when the client server 240 reads data of a file stored in the distributed storage.

In FIG. 7, a storage node A is a request receiving node that receives a request from the client server 240, and a storage node B is a divided file storage node that stores a divided file corresponding to the request from the client server 240.

Further, the client server 240 starts the read processing to a distributed storage program of any storage node A that constitutes the distributed storage at time of transmitting the read request. The distributed storage program of the storage node A that receives the read request identifies a divided file that stores data to be read based on information (path, offset, and size of a file from which the data is read) included in the read request (710).

Next, the distributed storage program of the storage node A transfers the read request to a distributed storage program of the storage node B that manages the divided file (711). When the data requested to be read spans a plurality of divided files, the distributed storage program of the storage node A transfers the read request to distributed storage programs of the plurality of storage nodes.

The distributed storage program of the storage node B to which the request is transferred refers to a pointer management table of the divided file (720), and confirms whether the data requested to be read includes duplicated data that has been deduplicated (721).

When the data requested to be read does not include the duplicated data, the distributed storage program of the storage node B reads the requested data from the divided file (721B) and transmits the read data to the storage node A that receives the read request (722B).

On the other hand, when the data requested to be read includes the duplicated data, the distributed storage program of the storage node B refers to the pointer management table and reads the requested data from a duplicated data storage file on the shared volume 223 (721A).

Next, the distributed storage program of the storage node B confirms whether the read request includes normal data that has not been deduplicated (722). When the read request does not include the normal data that has not been deduplicated, the distributed storage program of the storage node B transmits the read data to the storage node A that receives the read request (722B).

On the other hand, when the read request includes the normal data that has not been deduplicated, the distributed storage program of the storage node B reads the data from the divided file (721B), and transmits the read request together with the data read in the processing 721A to the storage node A that receives the read request (722B).

Next, the distributed storage program of the storage node A that receives the data confirms whether data is received from all nodes to which the request is transferred (712). When the distributed storage program of the storage node A receives the data from all the storage nodes, the distributed storage program transmits the data to the client server 240 and ends the process. When the data is not received from all the storage nodes, the process returns to the processing 712 and the confirmation processing is repeated.

In a write processing, the distributed storage supports both inline deduplication which performs the deduplication when data is written and post-process deduplication which performs the deduplication at any time.

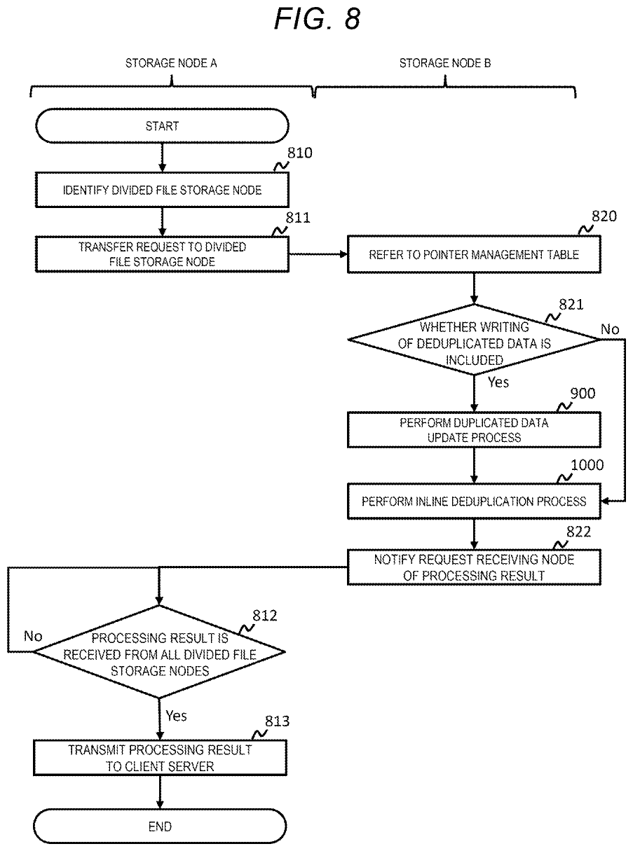

FIG. 8 is a flowchart showing an inline deduplication write processing of the distributed storage system according to the first embodiment. FIG. 8 shows the write processing when the client server 240 writes data in a file stored in the distributed storage at the time of inline deduplication.

In FIG. 8, the storage node A is a request receiving node that receives a request from the client server 240, and the storage node B is a divided file storage node that stores a divided file corresponding to the request from the client server 240.

Further, the client server 240 starts the write processing to a distributed storage program of any storage node A that constitutes the distributed storage at time of transmitting the write request. The distributed storage program of the storage node A that receives the write request identifies a divided file that is a write target based on information (path, offset, and size of a file in which data is written) included in the write request (810).

Next, the distributed storage program of the storage node A transfers the write request to a distributed storage program of the storage node B that manages the divided file, and requests for data duplication determination related to the write request (811). When the data requested to be written spans a plurality of divided files, the distributed storage program of the storage node A transfers the write request to distributed storage programs of the plurality of storage nodes.

The distributed storage program of the storage node B to which the request is transferred refers to a pointer management table of the divided file (820), and confirms whether data requested to be written includes the duplicated data that has been deduplicated (821).

When the data requested to be written includes the duplicated data, the distributed storage program of the storage node B performs a duplicated data update processing (900) and then performs an inline deduplication processing (1000).

On the other hand, when the data requested to be written does not include the duplicated data, the distributed storage program of the storage node B performs the inline deduplication process (1000).

Next, the distributed storage program of the storage node B notifies the distributed storage program of the storage node A that receives the write request of a processing result after the inline deduplication process (822).

Next, the distributed storage program of the storage node A that receives the processing result from the storage node B confirms whether the processing result is received from all storage nodes to which the request is transferred (812). When the distributed storage program of the storage node A receives the process result from all the storage nodes, the distributed storage program transmits the write processing result to the client server 240 and ends the process. When the processing result is not received from all the storage nodes, the process returns to the processing 812 and the confirmation processing is repeated.

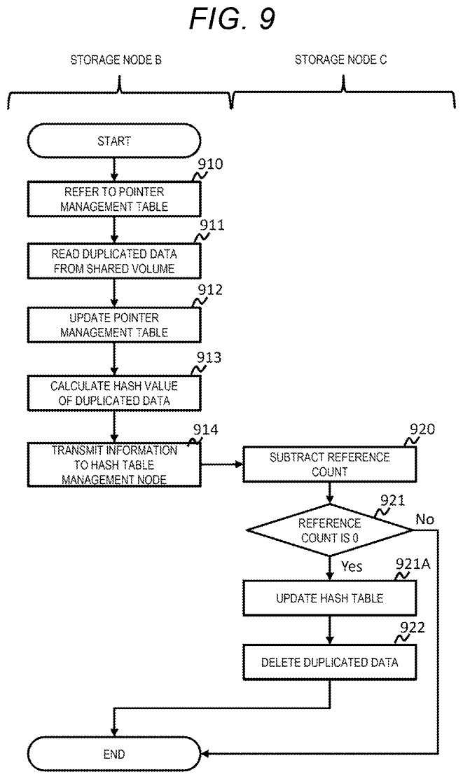

FIG. 9 is a flowchart showing the duplicated data update process of FIG. 8.

In FIG. 9, the storage node B is the divided file storage node that stores the divided file corresponding to the request from the client server 240, and a storage node C is a hash table management node that manages a hash value of duplicated data corresponding to the request from the client server 240.

Further, the distributed storage program of the storage node B that performs the duplicated data update processing of FIG. 8 refers to the pointer management table of the divided file in which the data is written (910).

Next, the distributed storage program of the storage node B reads the duplicated data from any one of duplicated data storage files on the shared volume 223 (911).

Next, the distributed storage program of the storage node B deletes an entry of corresponding duplicated data from the pointer management table (912).

Next, the distributed storage program of the storage node B calculates a hash value of the duplicated data read in the process 911 (913), and transmits information of the duplicated data to the storage node C including the hash table that manages the duplicated data (914).

Next, a distributed storage program of the storage node C that receives the information searches for an entry of the data recorded in its own hash table and subtracts a reference count of the data (920).

When the reference count of the data is not 0, the distributed storage program of the storage node C ends the process immediately.

On the other hand, when the reference count is 0, the distributed storage program of the storage node C deletes the entry of the data from the hash table (921A), deletes the duplicated data from the duplicated data storage file (922), and ends the process.

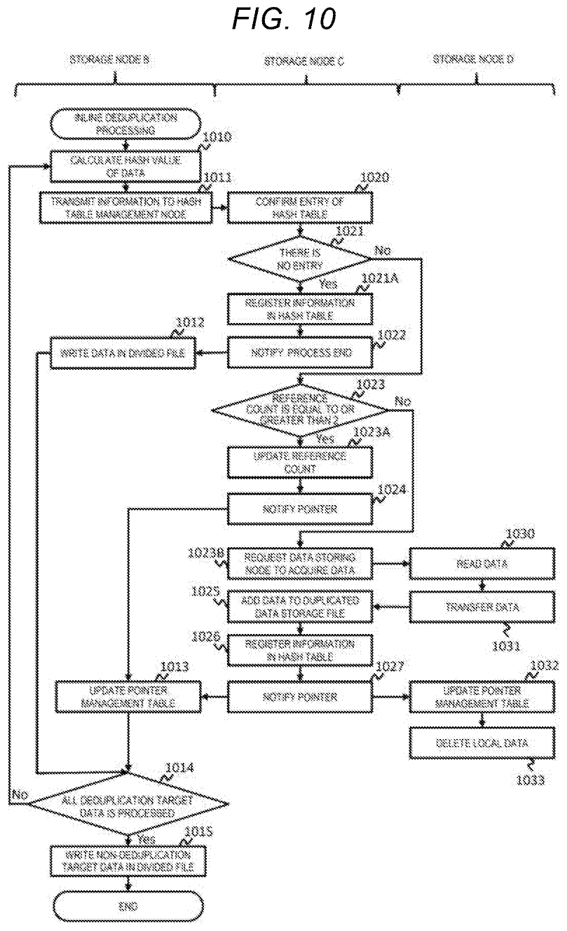

FIG. 10 is a flowchart showing the inline deduplication processing of FIG. 8.

In FIG. 10, the storage node B is the divided file storage node that stores the divided file corresponding to the request from the client server 240, the storage node C is the hash table management node that manages the hash value of the duplicated data corresponding to the request from the client server 240, and a storage node D is a data storing node that stores data duplicated with deduplication target data.

The distributed storage program of the storage node B that performs the inline deduplication processing calculates the hash value of the data to be written in the write processing (1010). At this time, the distributed storage program of the storage node B calculates the hash value for each piece of deduplication target data. For example, when the data to be written is 1000 bytes and the deduplication target data is 20th to 100th bytes from a beginning and 540th to 400th bytes from the beginning of the data to be written, the processing 1010 is performed twice.

Next, the distributed storage program of the storage node B transmits, based on the calculated hash value, information of the deduplicated data to the storage node C including the hash table that manages the deduplication target data (1011).

The distributed storage program of the storage node C that receives the information searches the hash table (1020) and confirms whether there is an entry of the deduplication target data in the hash table (1021).

When there is no entry in the hash table, the distributed storage program of the storage node C registers information (hash value, and path, offset, and size of the divided file that stores the deduplication target data) of the deduplication target data in the hash table, and sets a reference count to 1 (1021A).

Next, the distributed storage program of the storage node C notifies the storage node B that performs the inline deduplication processing of a process end (1022). The distributed storage program of the storage node B that receives the process end notification writes the deduplication target data in the divided file (1012).

Next, the distributed storage program of the storage node B confirms whether the processing of all the deduplication target data is completed (1014). When the processing of all the deduplication target data is completed, the distributed storage program of the storage node B also writes non-deduplication target data in the divided file (1015) and ends the inline deduplication processing. If not, the process is repeated from the processing 1010.

On the other hand, when there is an entry in the hash table in the process 1021, the distributed storage program of the storage node C confirms whether the reference count of the entry is equal to or greater than 2 (1023). When the reference count is equal to or greater than 2, the distributed storage program of the storage node C regards the data as the duplicated data and increments the reference count of the entry by 1 (1023A).

Next, the distributed storage program of the storage node C notifies the storage node B that performs the inline deduplication processing of information (path, offset, and size of the duplicated data storage file that stores the duplicated data) recorded in the entry as the pointer information (1024).

Next, the distributed storage program of the storage node B that receives the pointer information writes the received pointer information in the pointer management table of the divided file that should store the deduplication target data (1013). Further, the distributed storage program of the storage node B confirms whether the processing of all the deduplication target data is completed (1014). When the processing of all the deduplication target data is completed, the distributed storage program of the storage node B writes the non-deduplication target data in the divided file (1015) and ends the inline deduplication processing. If not, the process is repeated from the processing 1010.

On the other hand, when the reference count is not equal to or greater than 2 (when the reference count is 1) in the processing 1023, the distributed storage program of the storage node C requests, based on information of the entry of the hash table, the storage node D that stores the data duplicated with the deduplication target data, to acquire the duplicated data (1023B). A distributed storage program of the storage node D that receives the request reads the duplicated data from divided files stored in a volume allocated to itself (1030), and transfers the duplicated data to the storage node C that is requested for the duplicated data acquisition (1031).

The distributed storage program of the storage node C that receives the duplicated data adds the duplicated data to the duplicated data storage file allocated to itself (1025). At this time, the distributed storage program of the storage node C may perform byte comparison to determine whether the deduplication target data and the duplicated data do duplicate. When the duplicated data is added to the duplicated data storage file, the distributed storage program of the storage node C overwrites a path, an offset, and a size of the entry of the duplicated data in the hash table so as to correspond to a path, an offset, and a size of the duplicated data stored in the duplicated data storage file (1026).

Next, the distributed storage program of the storage node C notifies the storage node B that performs the inline deduplication processing and the storage node D that stores the duplicated data of the pointer information (path, offset, and size of the duplicated data storage file that stores the duplicated data) of the duplicated data (1027).

The distributed storage program of the storage node D that stores the duplicated data and receives the notification updates the pointer management table of the divided file in which the duplicated data is stored with the received pointer information (1032), and deletes local duplicated data stored in the divided file (1033).

The distributed storage program of the storage node B that performs the inline deduplication process and receives the notification updates the pointer management table of the divided file in which the duplicated data is stored with the received pointer information (1013).

Next, the distributed storage program of the storage node B confirms whether the processing of all the deduplication target data is completed (1014). When the processing of all the deduplication target data is completed, the distributed storage program of the storage node B writes the non-deduplication target data in the divided file (1015) and ends the inline deduplication processing. If not, the process is repeated from the processing 1010.

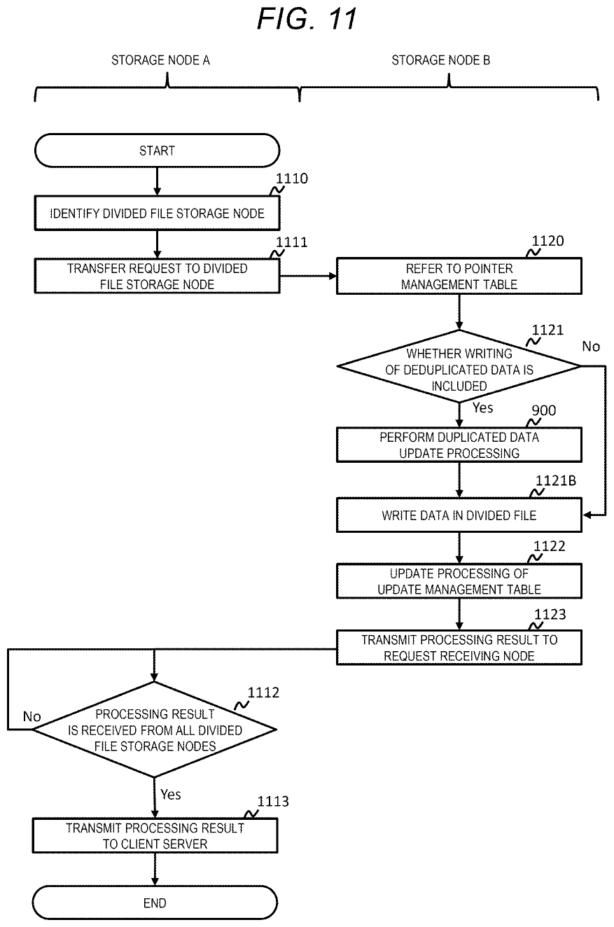

FIG. 11 is a flowchart showing a post-process deduplication write processing of the distributed storage system according to the first embodiment. FIG. 11 shows the write processing when the client server 240 writes the data in the file stored in the distributed storage at the time of post-process deduplication.

In FIG. 11, the client server 240 starts the write processing to the distributed storage program of any storage node A that constitutes the distributed storage at the time of transmitting the write request. The distributed storage program of the storage node A that receives the write request identifies the divided file that is an execution target of the write processing based on the information (path, offset, and size of the file in which the data is written) included in the write request (1110).

Next, the distributed storage program of the storage node A transfers the write request to the distributed storage program of the storage node B that manages the divided file (1111). When the data requested to be written spans the plurality of divided files, the distributed storage program of the storage node A transfers the write request to the distributed storage programs of the plurality of storage nodes.

The distributed storage program of the storage node B to which the request is transferred refers to the pointer management table of the divided file (1120), and confirms whether the data requested to be written includes the duplicated data that has been deduplicated (1121).

When the data requested to be written includes the duplicated data, the distributed storage program of the storage node B performs the duplicated data update processing 900, and then writes the data in the divided file (1121B).

On the other hand, in the processing 1121, when the data requested to be written does not include the duplicated data, the distributed storage program of the storage node B writes the data in the divided file immediately (1121B).

Next, the distributed storage program of the storage node B records an offset and a size at a beginning of a portion where the data is written in the update management table of the divided file (1122).

Next, the distributed storage program of the storage node B notifies the distributed storage program of the storage node A that receives the write request of the processing result (1123).

Next, the distributed storage program of the storage node A that receives the processing result from the storage node B confirms whether the processing result is received from all the storage nodes to which the request is transferred (1112). When the distributed storage program of the storage node A receives the processing result from all the storage nodes, the distributed storage program transmits the result of the write processing to the client server 240 and ends the process. When the processing result is not received from all the storage nodes, the process returns to the processing 1112 and the confirmation processing is repeated.

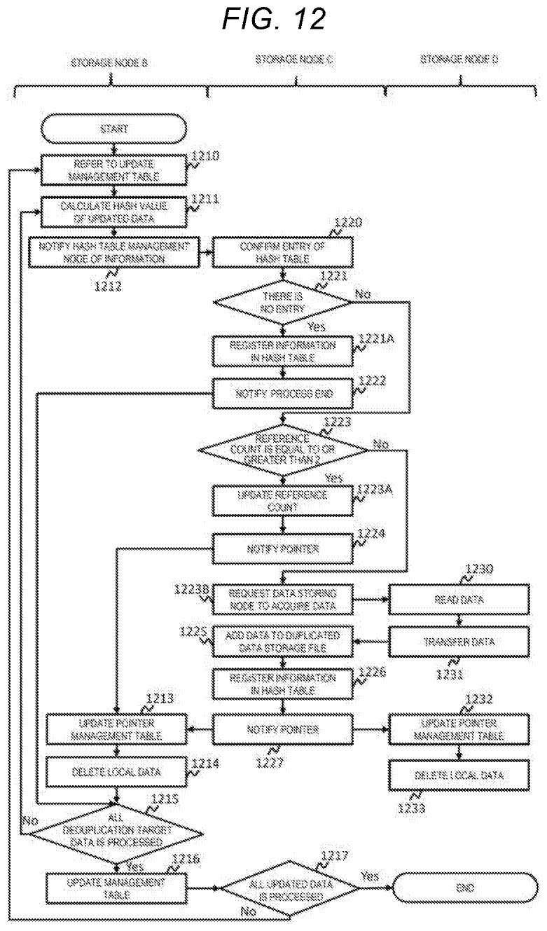

FIG. 12 is a flowchart showing a post-process deduplication processing of the distributed storage system according to the first embodiment.

In FIG. 12, the distributed storage program of the storage node B that performs the post-process deduplication processing refers to the update management table of the divided file managed by itself (1210).

Next, the distributed storage program of the storage node B reads the updated data among the data stored in the divided file and calculates the hash value (1211). At this time, the distributed storage program of the storage node B calculates the hash value for each piece of deduplication target data. For example, when the read updated data is 1000 bytes and the deduplication target data is 20th to 100th bytes from a beginning and 540th to 400th bytes from the beginning of the data to be written, the processing 1211 is performed twice.

Next, the distributed storage program of the storage node B transmits, based on the calculated hash value, the information of the deduplicated data to the storage node C including the hash table that manages the deduplication target data (1212).

The distributed storage program of the storage node C that receives the information searches the hash table (1220) and confirms whether there is an entry of the deduplication target data in the hash table (1221).

When there is no entry in the hash table, the distributed storage program of the storage node C registers the information (hash value, and path, offset, and size of the divided file that stores the deduplication target data) of the deduplication target data in the hash table, and sets the reference count to 1 (1221A).

Next, the distributed storage program of the storage node C notifies the storage node B that performs the post-process deduplication of the process end (1222). The distributed storage program of the storage node B that receives the process end notification confirms whether the processing of all the deduplication target data is completed (1215). When the processing of all the deduplication target data is completed, the distributed storage program of the storage node B deletes the entry of the processed updated data from the update management table (1216) and confirms whether all the updated data is processed (1217).

When all the updated data is processed, the distributed storage program of the storage node B ends the post-process deduplication processing. If not, the process is repeated from the processing 1210.

On the other hand, when the processing of all the deduplication target data is not ended in the processing 1215, the distributed storage program of the storage node B repeatedly performs processing after the processing 1211.

On the other hand, when there is an entry in the hash table in the processing 1221, the distributed storage program of the storage node C confirms whether the reference count of the entry is equal to or greater than 2 (1223). When the reference count is equal to or greater than 2, the distributed storage program of the storage node C regards the data as the duplicated data and increments the reference count of the entry by 1 (1223A).

Next, the distributed storage program of the storage node C notifies the storage node B that performs the post-process deduplication of the information (path, offset, and size of the duplicated data storage file that stores the duplicated data) recorded in the entry as the pointer information (1224).

Next, the distributed storage program of the storage node B that receives the pointer information writes the received pointer information in the pointer management table of the divided file that stores the deduplication target data (1213). Further, the distributed storage program of the storage node B deletes the local deduplication target data stored in the divided file (1214).

Next, the distributed storage program of the storage node B confirms whether the processing of all the deduplication target data is completed (1215). When the processing of all the deduplication target data is completed, the distributed storage program of the storage node B deletes the entry of the processed updated data from the update management table (1216) and confirms whether all the updated data is processed (1217).

When all the updated data is processed, the distributed storage program of the storage node B ends the post-process deduplication processing. If not, the process is repeated from the processing 1210.

On the other hand, when the processing of all the deduplication target data is not ended in the processing 1215, the distributed storage program of the storage node B repeatedly performs processing after the processing 1211.

On the other hand, when the reference count is not equal to or greater than 2 (when the reference count is 1) in the processing 1223, the distributed storage program of the storage node C requests, based on the information of the entry of the hash table, the storage node D that stores the data duplicated with the deduplication target data, to acquire the duplicated data (1223B). The distributed storage program of the storage node D that receives the request reads the duplicated data from the divided files stored in the volume allocated to itself (1230), and transfers the duplicated data to the storage node C that is requested the duplicated data acquisition (1231).

The distributed storage program of the storage node C that receives the duplicated data adds the duplicated data to the duplicated data storage file allocated to itself (1225). At this time, the distributed storage program of the storage node C may perform the byte comparison to determine whether the deduplication target data and the duplicated data do duplicate. When the duplicated data is added to the duplicated data storage file, the distributed storage program of the storage node C overwrites the path, the offset, and the size of the entry of the duplicated data in the hash table so as to correspond to the path, the offset, and the size of the duplicated data stored in the duplicated data storage file (1226).

Next, the distributed storage program of the storage node C notifies the storage node B that performs the inline deduplication processing and the storage node D that stores the duplicated data of the pointer information (path, offset, and size of the duplicated data storage file that stores the duplicated data) of the duplicated data (1227).

The distributed storage program of the storage node B that stores the duplicated data and receives the notification updates the pointer management table of the divided file in which the duplicated data is stored with the received pointer information (1232), and deletes the local duplicated data stored in the divided file (1233).

The distributed storage program of the storage node B that performs the inline deduplication processing and receives the notification updates the pointer management table of the divided file in which the duplicated data is stored with the received pointer information (1213). Further, the distributed storage program of the storage node B deletes the local deduplication target data stored in the divided file (1214).

Next, the distributed storage program of the storage node B confirms whether the processing of all the deduplication target data is completed (1215). When the processing of all the deduplication target data is completed, the distributed storage program of the storage node B deletes the entry of the processed updated data from the update management table (1216) and confirms whether all the updated data is processed (1217).

When all the updated data is processed, the distributed storage program of the storage node B ends the post-process deduplication processing. If not, the process is repeated from the processing 1210.

On the other hand, when the processing of all the deduplication target data is not ended in the processing 1215, the distributed storage program of the storage node B repeatedly performs the processing after the processing 1211.

### Second Embodiment

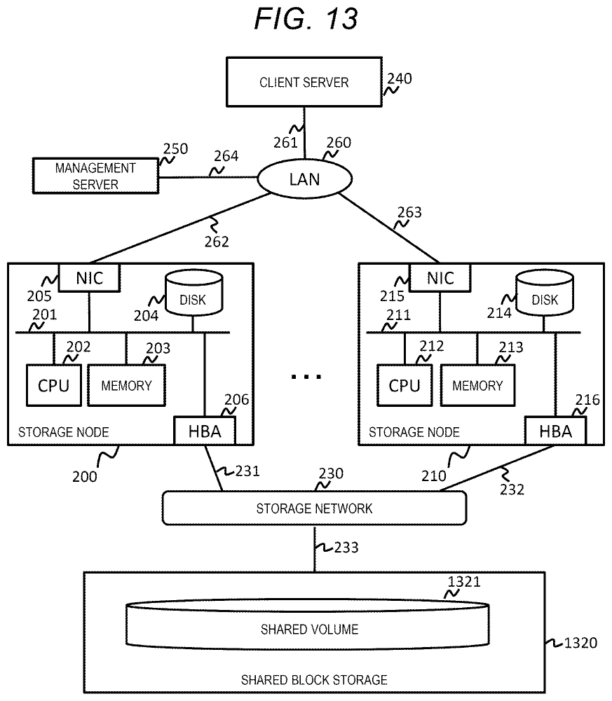

FIG. 13 is a block diagram showing an example of a hardware configuration of a distributed storage system according to a second embodiment.

In FIG. 13, the distributed storage system includes a shared block storage 1320 instead of the shared block storage 220 of FIG. 3. The shared block storage 1320 is shared by a plurality of storage nodes 200 to 210. The shared block storage 1320 includes a shared volume 1321 accessible from any of the storage nodes 200 to 210. The shared volume 1321 stores each file on the distributed file system and duplicated data on the file system.

At this time, all pointer management tables for managing pointer information to the duplicated data are stored in one shared volume 1321. Therefore, it is possible to know which duplicated data storage file the duplicate data from one of the storage nodes 200 to 210 is stored in. As a result, the duplicated data in any of the storage nodes 200 to 210 can be read from the shared volume 1321. When data that is a read target is the duplicated data only, communication among the storage nodes 200 to 210 does not occur and the IO performance can be improved.

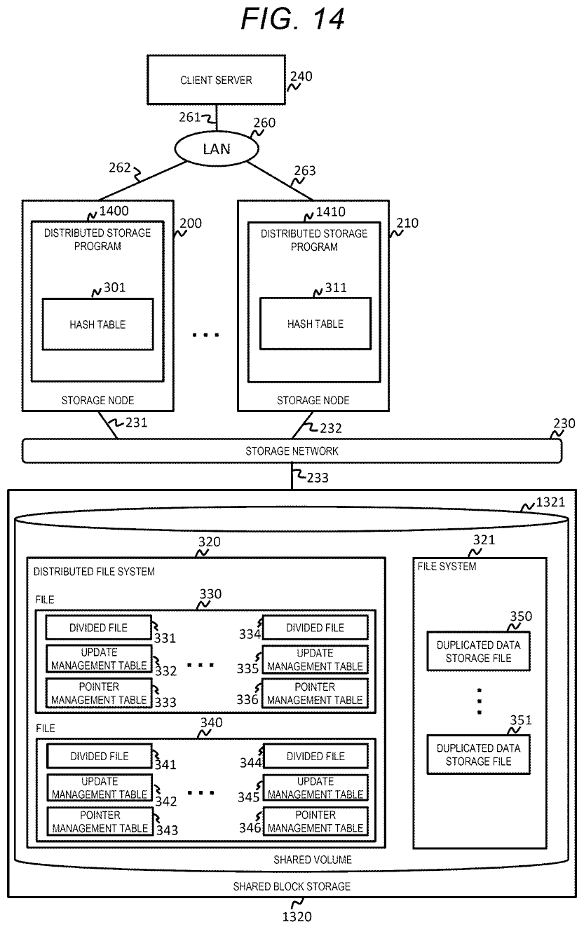

FIG. 14 is a block diagram showing an example of a theoretical configuration of the distributed storage system according to the second embodiment.

In FIG. 14, the storage nodes 200 to 210 respectively include distributed storage programs 1400 to 1410 instead of the distributed storage programs 300 to 310 of FIG. 3.

The distributed storage program 1400 executed on the storage node 200, the distributed storage program 1410 executed on the storage node 210, and distributed storage programs (not shown in the figure) operating on the other storage nodes operate in coordination to constitute the distributed storage.

The distributed storage of FIG. 3 constructs the distributed file system 320 across the plurality of volumes 221 to 222 on the shared block storage 220, whereas the distributed storage of FIG. 14 constructs the distributed file system 320 in the shared volume 1321 on the shared block storage 1320. Therefore, all the storage nodes 200 to 210 can access all the pointer management tables 333, 336, 343, and 346 that manage the pointer information to the duplicated data stored in the duplicated data storage files 350 to 351. As a result, it is possible to know which one of the duplicated data storage files 350 to 351 the duplicate data from one of the storage nodes 200 to 210 is stored in, and the duplicated data can be read from the shared volume 1321.

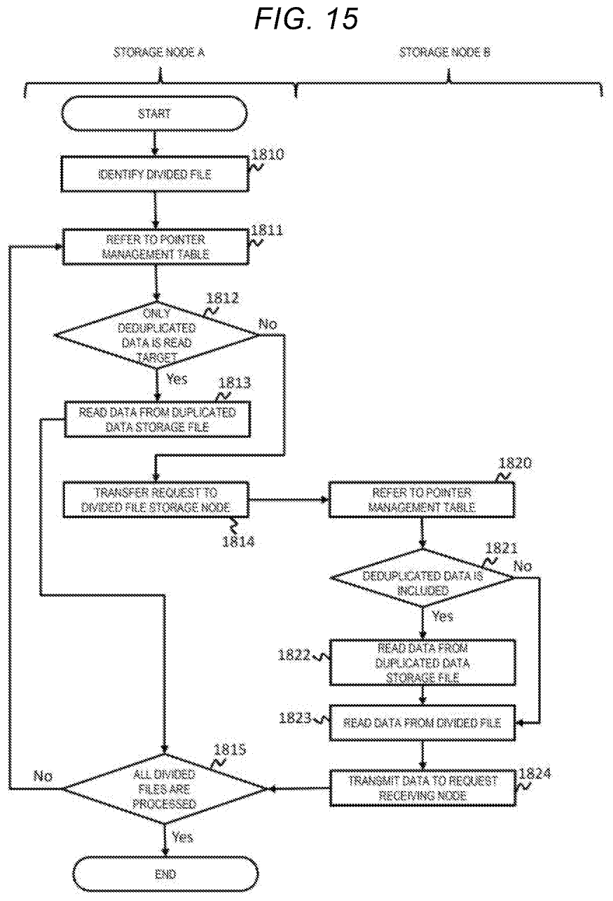

FIG. 15 is a flowchart showing a read processing of the distributed storage system according to the second embodiment.

In FIG. 15, the client server 240 starts the read processing to a distributed storage program of any storage node A that constitutes the distributed storage at the time of transmitting a read request. The distributed storage program of the storage node A that receives the read request identifies a divided file that stores data required to be read based on information (path, offset, and size of the file from which the data is read) included in the read request (1810).

Next, the distributed storage program of the storage node A refers to a pointer management table of the divided file (1811), and confirms whether only deduplicated data is the read target (1812).

When only the deduplicated data is the read target, the distributed storage program of the storage node A refers to the pointer management table and reads the requested data from a duplicated data storage file on the shared volume 1321 (1813).

Next, the distributed storage program of the storage node A confirms whether all divided files identified in the processing 1810 are processed (1815). When all the divided files are processed, the distributed storage program of the storage node A ends the process. If not, the processing after the processing 1811 is repeated.

On the other hand, when not only the deduplicated data is not the read target, the distributed storage program of the storage node A transfers the read request to a distributed storage program of the storage node B that manages the divided file (1814).

The distributed storage program of the storage node B to which the request is transferred refers to the pointer management table of the divided file (1820), and confirms whether the read request data includes the duplicated data that has been deduplicated (1821).

When the read request data does not include the duplicated data, the distributed storage program of the storage node B reads the requested data from the divided file (1823) and transmits the read data to the storage node A that receives the read request (1824).

On the other hand, when the read request data includes the duplicated data, the distributed storage program of the storage node B refers to the pointer management table and reads the requested data from the duplicated data storage file on the shared volume 223 (1822). Further, the distributed storage program of the storage node B reads normal data that has not been deduplicated from the divided file (1823), and transmits the normal data together with the data read in the processing 1822 to the storage node A that receives the read request (1824).

Next, the distributed storage program of the storage node A confirms whether all the divided files identified in the processing 1810 are processed (1815). When all the divided files are processed, the distributed storage program of the storage node A ends the process. If not, the processing after the processing 1811 is repeated.

Herein, when the data that is the read target is the duplicated data only and the process proceeds in an order of processing 1810→1811→1812→1813→1815 and communication between the storage nodes A and B does not occur, the IO performance can be improved.

Regarding a write processing, the distributed storage of FIG. 14 can be performed in a similar manner as the process of FIGS. 8 to 12.

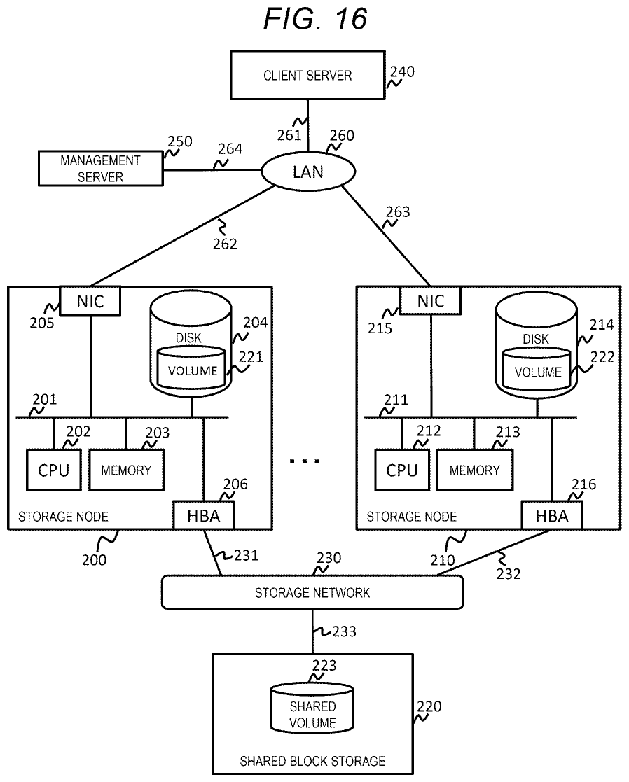

FIG. 16 is a block diagram showing an example of a hardware configuration of a distributed storage system according to a third embodiment.

In FIG. 16, the hardware configuration of the distributed storage system is similar to the hardware configuration of the distributed storage system of FIG. 2.

However, in the distributed storage system of FIG. 2, the volumes 221 to 222 respectively managed by the storage nodes 200 to 210 are stored in the shared block storage 220, whereas in the distributed storage system of FIG. 16, the volumes 221 to 222 respectively managed by the storage nodes 200 to 210 are respectively stored in the disks 204 to 214 of the storage nodes 200 to 210.

By storing the volumes 221 to 222 managed by the respective storage nodes 200 to 210 in the disks 204 to 214, the storage nodes 200 to 210 can access the volumes 221 to 222 without communication via the storage network 230.

The invention is not limited to the above-mentioned embodiments, and includes various modifications. For example, the above-mentioned embodiments have been described in detail for easy understanding of the invention, and are not necessarily limited to those including all the configurations described above. A part of configurations of an embodiment may be replaced with configurations of another embodiment, or the configurations of another embodiment may be added to the configurations of the embodiment. A part of the configuration of each embodiment may be added to, deleted from, or replaced with another configuration. Further, a part or all of the above-mentioned configurations, functions, processing units, processing methods, and the like may be implemented by hardware, for example, by designing an integrated circuit.

What is claimed is:

1. A distributed storage device comprising:
a plurality of storage nodes; and
a storage device configured to physically store data, wherein
each of the storage nodes has
information on a storage destination of the data stored in the storage device, and
a deduplication function, and
in the deduplication function,
any one of the plurality of storage nodes determines whether data that is a processing target duplicates with the data stored in the storage device,
when it is determined that the data is duplicated, deduplication of the data that is the processing target is performed by storing the information on the storage destination of the data in the storage device that is related to the duplication with a storage node that processes the data that is the processing target, and
when a read request of the data is received, the storage node that processes the data that is the processing target reads the data in the storage device using the stored information on the storage destination.

2. The distributed storage device according to claim 1, wherein
the storage node that determines the duplication has a list of hash values of the data stored in the storage device as the information on the storage destination,
a hash value of the data that is the processing target is compared with the list of hash values,
when there is no hash value in the list matching the hash value of the data that is the processing target, the hash value of the data that is the processing target is added to the list, and
when there is a hash value in the list matching the hash value of the data that is the processing target, the data that is the processing target is compared with the data having the hash value in the list to determine the deduplication.

3. The distributed storage device according to claim 2, wherein
the storage node that determines the duplication acquires the data that is the processing target from the storage node that processes the data that is the processing target,
when there is the matching hash value, data related to the hash value is acquired from a node related to the matching hash value in the list, and
in the determination of the deduplication, when the data that is the processing target is compared with the data having the hash value in the list and match, the storage node that processes the data that is the processing target and the node related to the matching hash value in the list are notified of information on the data.

4. The distributed storage device according to claim 1, wherein
when it is determined that the data is duplicated, a node that manages the data in the storage device related to the duplication stores deduplication information indicating that the deduplication is performed in association with the data.

5. The distributed storage device according to claim 4, wherein
the storage device is provided with a shared volume that stores deduplicated data and an individual volume that stores data that has not been deduplicated, and
when the data in the individual volume is deduplicated, the data is moved to the shared volume.

6. The distributed storage device according to claim 5, wherein
the individual volume is provided for each storage node.

7. The distributed storage device according to claim 5, wherein
when a deletion request is received for the data in the individual volume, the data is deleted,
when a deletion request is received for the data in the shared volume, the deduplication information is updated, and
in the deduplication information, when there is no entry that refers to the data in the shared volume, the data in the shared volume is deleted.

8. The distributed storage device according to claim 7, wherein
when a deletion request is received for the deduplicated data, the node that processes the data deletes the information on the storage destination and notifies the node that manages the data, and
the node that manages the data and receives the notification updates the deduplication information.

9. The distributed storage device according to claim 5, wherein
when an update write request is received for the data in the individual volume, the data is updated and written,
when an update write request is received for the data in the share volume, the deduplication information is updated, and the data related to the update write request is stored in an individual volume related to the node that processes the data, and
in the deduplication information, when there is no entry that refers to the data in the shared volume, the data in the shared volume is deleted.

10. The distributed storage device according to claim 1, wherein
the storage node that processes the data that is the processing target performs a deduplication processing by receiving a write request and requesting the node that determines the deduplication for duplication determination of data related to the write request, and
when it is determined that the data is duplicated, the storage node that processes the data that is the processing target does not store the data related to the write request in the storage device, but stores the information on the storage destination of the data.

11. The distributed storage device according to claim 1, wherein
the storage node that processes the data that is the processing target performs, for its own data stored in the storage device, a deduplication processing by requesting the node that determines the deduplication for duplication determination of data related to a write request, and
when it is determined that the data is duplicated, the storage node that processes the data that is the processing target deletes the data stored in the storage device, and stores the information on the storage destination of the data.

12. The distributed storage device according to claim 1, wherein
for each piece of the data, a node having the information on the storage destination of the data in the storage device and in charge of an input and output is defined,
a node that receives a data input and output request transfers the data input and output request to a node in charge of an input and output of the data, and
the node that receives the transfer processes the input and output request by accessing the storage device using the information on the storage destination of the data.

13. A data management method for a distributed storage device including a plurality of storage nodes and a storage device that physically stores data, each of the storage nodes having information on a storage destination of the data stored in the storage device and a deduplication function, the data management method for the distributed storage device comprising:
in the deduplication function,
determining, by any one of the plurality of storage nodes, whether data that is a processing target duplicates with the data stored in the storage device,
when it is determined that the data is duplicated, performing deduplication of the data that is the processing target by storing the information on the storage destination of the data in the storage device that is related to the duplication with a storage node that processes the data that is the processing target, and
when a read request of the data is received, reading, by the storage node that processes the data that is the processing target, the data in the storage device using the stored information on the storage destination.
